(19) United States
(12) Patent Application Publication
(10) Pub. No.: US 2026/0244592 A1
(43) Pub. Date: Aug. 20, 2026

(54) DUAL-EDGE DATA BUS INVERSION TO REDUCE IR DROP

(71) Applicant: NVIDIA Corporation, Santa Clara, CA (US)

(72) Inventors: Karan GUPTA, Uttar Pradesh (IN); Dane T. MRAZEK, Redwood City, CA (US); Supratim DAS, Bengaluru (IN); Kirk Edward TWARDOWSKI, Mountain View, CA (US)

(21) Appl. No.: 19/056,533

(22) Filed: Feb. 18, 2025

(51) Int. Cl. G06F 13/42

(52) U.S. Cl. CPC G06F 13/4291

(57) ABSTRACT

Various embodiments include techniques for reducing IR drop in an electronic circuit. IR drop results from simultaneous transitioning of a large number of electronic signals of an interconnect in a densely packed area. This IR drop can result in data errors and malfunctioning circuit components. To mitigate such IR drops, the disclosed techniques stagger the electronic signals such that one half of the signals transition at the positive edge of a synchronizing clock signal and one half of the signals transition at the negative edge of the synchronizing clock signal. Further, selective data bus inversion is applied to each half of the electronic signals. When applied together, these two techniques limit simultaneous transition to 25% of the total number of the electronic signals of the interconnect, thereby reducing IR drop relative to prior conventional approaches.

### BACKGROUND

### Field of the Various Embodiments

Various embodiments relate generally to signal transmission systems and, more specifically, to improved dual-edge data bus inversion to reduce IR drop.

### Description of the Related Art

A computing system generally includes, among other things, one or more processing units, such as central processing units (CPUs) and/or graphics processing units (GPUs), and one or more memory systems. In general, the CPU functions as the master processor of the computing system, controlling and coordinating operations of other system components such as the GPUs. The CPU often has access to a large amount of low bandwidth system memory. GPUs, on the other hand, often have access to a smaller amount of high bandwidth local memory. As a result, the CPU is able to accommodate application programs that consume a large amount of memory and do not require high bandwidth from the memory. GPUs, on the other hand, are able to accommodate processes that consume a smaller amount of memory and require high bandwidth from the memory. In particular, GPUs are capable of executing a large number (e.g., hundreds or thousands) of threads concurrently, where each thread is an instance of an independent sequence of instructions. As a result, GPUs are well suited for parallelizable threads that benefit from high bandwidth memory to achieve high performance for specific tasks.

Over time, new generations of GPUs increase in performance by increasing the density of components on the integrated circuit that includes the GPU. This increase in density, in turn, increases clock speed and increases the number of processors which correspondingly increases the number of concurrently executing threads, and increases the number of bits in the memory data path. As a result, the memory bandwidth consumed by GPUs increases over time. The set of signals between components of a computing system is referred to as an interconnect. For example, the set of address, data, and clock (synchronization) signals between the GPU and memory is referred to as a memory interconnect. Correspondingly, as the memory bandwidth consumed by GPUs increases over time, the signal density and signal speed of the memory interconnect between the GPU and memory also increases over time.

One drawback of this increase in interconnect signal density and signal speed is that a large number of signals, and the flip-flops that store and transmit those signals, can simultaneously transition, switch, or toggle between voltage levels in a densely packed area. The transition of a large number of signals in a densely packed area can cause the supply voltage (Vdd) to suddenly decrease temporarily. This supply voltage decrease is referred to as a current × resistance (IR) drop. If the signal transition between voltage levels is a one-time occurrence, then the supply voltage can return to the nominal voltage with little to no IR drop. If, however, the interconnect signals continue to simultaneously transition between voltage levels, the IR drop can continue such that the GPU, or portion thereof, operates at a reduced supply voltage level. Operating at a reduced supply voltage level can cause various problems, including reduced performance, bit errors when writing data to or reading data from memory, and functional failures of GPU and memory components that experience sustained IR drops. Further, continued increases in signal density and signal speed with new generations of computing systems can cause similar IR drops over interconnects to components other than the GPU and memory, such as interconnects with CPUs, network interfaces, and/or the like.

One approach for mitigating IR drops is to reduce the signal density by laying out signal interconnects so as to increase the distance between adjacent signals that can simultaneously transition. However, this decrease in signal density can lead to increased surface area of integrated circuits, substrates, printed circuit boards, and/or the like to which the GPU and memory are mounted. Further, decreasing signal density can lead to more complexity with respect to minimum supply voltage (Vmin), physical design (PD), and place and route (PnR) considerations for such integrated circuits, substrates, printed circuit boards, and/or the like.

Another approach for mitigating IR drops is to is to limit the number of signals in an interconnect that can transition simultaneously on the positive (rising) edge of the clock signal. This technique is referred to data bus inversion (DBI). With DBI, simultaneous switching of signals on the memory interconnect can be limited to no more than 50% of the signals. However, as signal density and signal speed continue to increase, voltage level switching on memory interconnects can cause significant IR drops, even when DBI is implemented.

As the foregoing illustrates, what is needed in the art are more effective techniques for transmitting signals between components over an interconnect in a computing system.

### SUMMARY

Various embodiments of the present disclosure set forth a computer-implemented method for transmitting data bus inversion (DBI) encoded electronic signals for an interconnect included in a computing system. The method includes synchronizing a first group of the DBI encoded electronic signals to a first edge of a synchronizing clock signal. The method further includes synchronizing a second group of the DBI encoded electronic signals to a second edge of the synchronizing clock signal. The method further includes transmitting the first group of the DBI encoded electronic signals and the second group of the DBI encoded electronic signals to a receiver.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, the simultaneous transitioning of electronic signals in an interconnect is limited to 25% of the electronic signals on the positive edge of the clock signal and 25% of the electronic signals on the negative edge of the clock signal. By contrast, with prior conventional DBI techniques, the simultaneous transitioning of electronic signals in an interconnect can be up to 50% of the electronic signals. Therefore, the disclosed techniques reduce simultaneous switching by as much as 50% relative to conventional DBI approaches and as much as 75% relative to systems with that do not employ DBI. As a result, the IR drop resulting from simultaneous transitioning of electronic signals in an interconnect can be reduced significantly as compared to conventional approaches. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the auxiliary processing subsystem of FIG. 1, according to various embodiments;

FIG. 3 is a block diagram of a general processing cluster (GPC) included in the parallel processing unit (PPU) of FIG. 2, according to various embodiments;

FIGS. 4A-4C set forth a block diagram of a dual edge data bus inversion (DBI) system for transmitting electronic signals for an interconnect included in the computing system of FIGS. 1-3, according to various embodiments;

FIG. 5 is a flow diagram of method steps for transmitting electronic signals for an interconnect with the dual edge DBI system of FIGS. 4A-4C, according to various embodiments;

FIGS. 6A-6C set forth a block diagram of a dual edge DBI system with an external DBI encoder and an external DBI decoder for transmitting electronic signals for an interconnect included in the computing system of FIGS. 1-3, according to various embodiments; and

FIG. 7 is a flow diagram of method steps for transmitting electronic signals for an interconnect with the dual edge DBI system of FIGS. 6A-6C, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

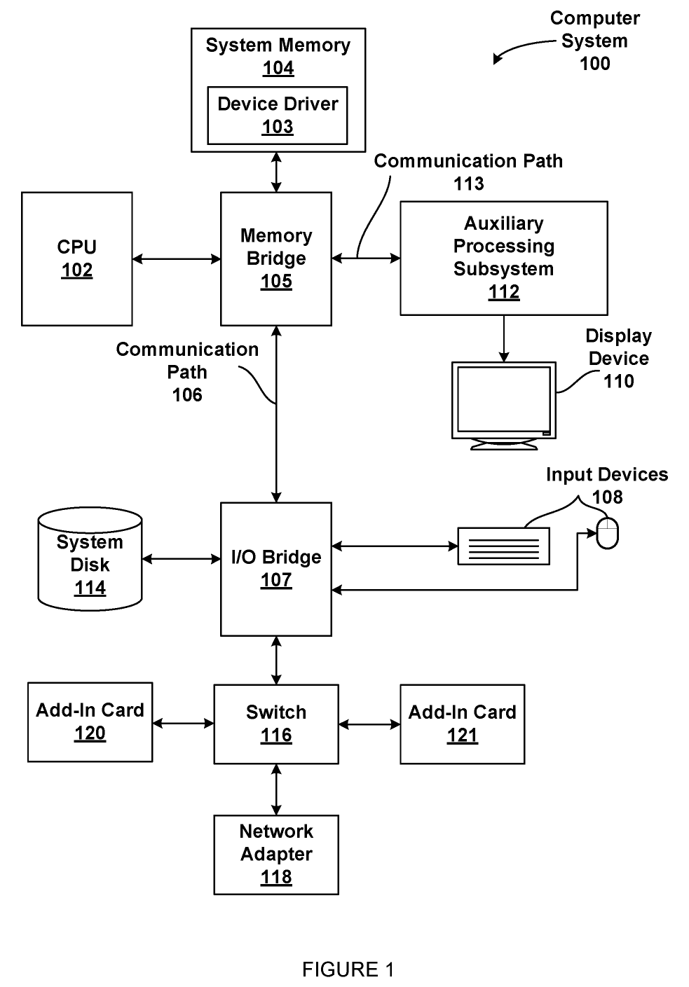

FIG. 1 is a block diagram of a computing system 100 configured to implement one or more aspects of the various embodiments. As shown, computing system 100 includes, without limitation, a central processing unit (CPU) 102 and a system memory 104 coupled to an auxiliary processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and auxiliary processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

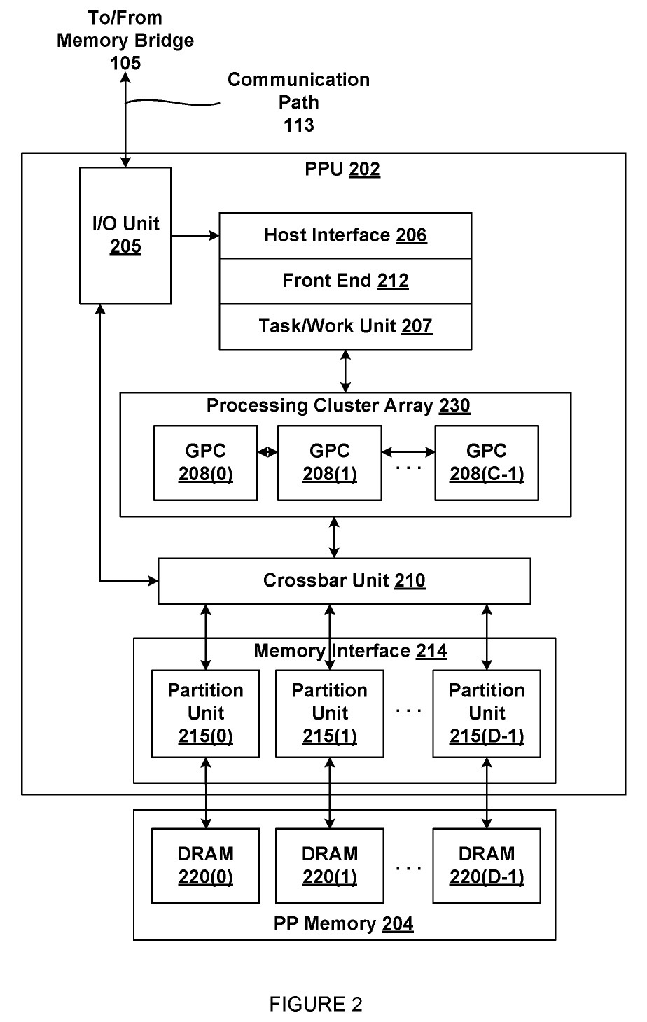

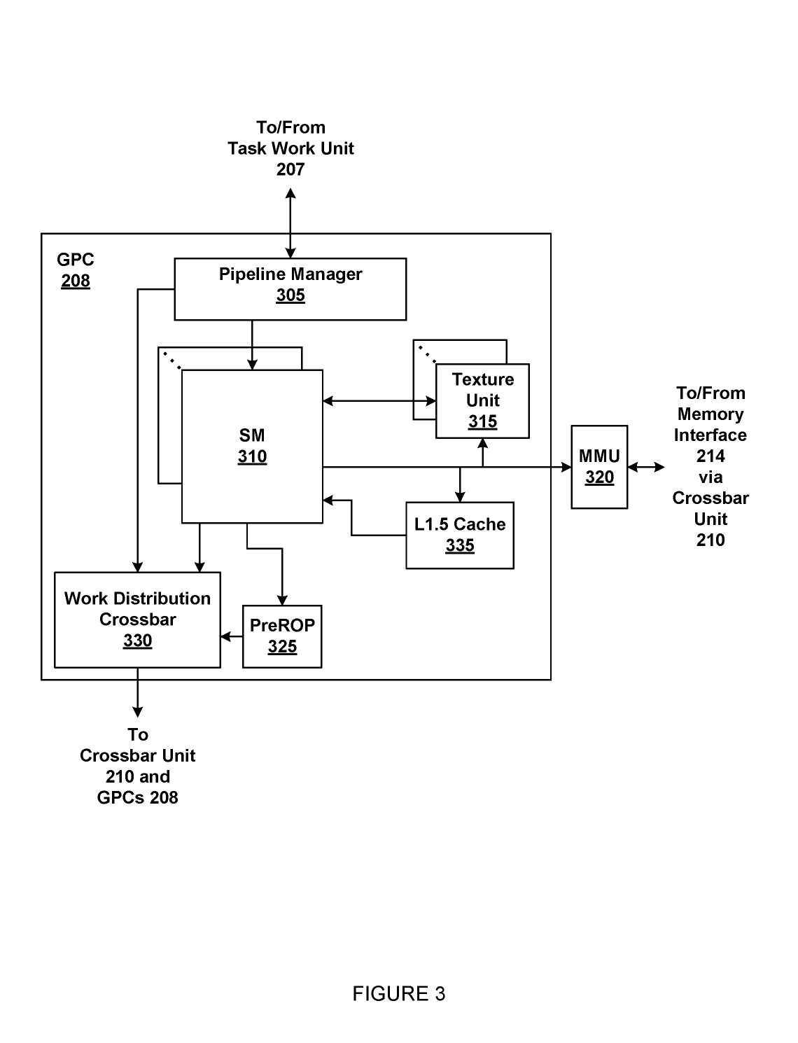

In some embodiments, auxiliary processing subsystem 112 comprises a graphics subsystem that delivers pixels to a display device 110 that may be any conventional cathode ray tube, liquid crystal display, light-emitting diode display, or the like. In such embodiments, the auxiliary processing subsystem 112 incorporates circuitry optimized for graphics and video processing, including, for example, video output circuitry. As described in greater detail below in FIG. 2, such circuitry may be incorporated across one or more auxiliary processors included within auxiliary processing subsystem 112. An auxiliary processor includes any one or more processing units that can execute instructions such as a reduced instruction set computer (RISC) processor, central processing unit (CPU), a parallel processing unit (PPU) of FIGS. 2-3, a graphics processing unit (GPU), a direct memory access (DMA) unit, an intelligence processing unit (IPU), a neural processing unit (NAU), a tensor processing unit (TPU), a neural network processor (NNP), a data processing unit (DPU), a vision processing unit (VPU), an application specific integrated circuit (ASIC), a field-programmable gate array (FPGA), and/or the like.

In some embodiments, auxiliary processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of auxiliary processors disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the auxiliary processing subsystem 112 incorporates circuitry optimized for general purpose and/or compute processing. Again, such circuitry may be incorporated across one or more auxiliary processors included within auxiliary processing subsystem 112 that are configured to perform such general purpose and/or compute operations. In yet other embodiments, the one or more auxiliary processors included within auxiliary processing subsystem 112 may be configured to perform graphics processing, general purpose processing, and compute processing operations. System memory 104 includes at least one device driver 103 configured to manage the processing operations of the one or more auxiliary processors within auxiliary processing subsystem 112.

In various embodiments, auxiliary processing subsystem 112 may be integrated with one or more other the other elements of FIG. 1 to form a single system. For example, auxiliary processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of auxiliary processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, auxiliary processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the auxiliary processing subsystem 112 of FIG. 1, according to various embodiments. Although FIG. 2 depicts one PPU 202, as indicated above, auxiliary processing subsystem 112 may include any number of PPUs 202. Further, the PPU 202 of FIG. 2 is one example of an auxiliary processor included in auxiliary processing subsystem 112 of FIG. 1. Alternative auxiliary processors include, without limitation, RISCs, CPUs, GPUs, DMA units, IPUs, NPUs, TPUs, NNPs, DPUs, VPUs, ASICs, FPGAs, and/or the like. The techniques disclosed in FIGS. 2-3 with respect to PPU 202 apply equally to any type of auxiliary processor(s) included within auxiliary processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or auxiliary processors other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, auxiliary processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C ≥ 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D ≥ 1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within auxiliary processing subsystem 112, or another auxiliary processing subsystem 112 within computing system 100.

As noted above, any number of PPUs 202 may be included in an auxiliary processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M ≥ 1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), PP memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, PP memory 204, or system memory 104. Please also note, as used herein, references to cache memory may include any one or more technically feasible memories, including, without limitation, an L1 cache, an L1.5 cache, and the L2 caches.

### Improved Dual-Edge Data Bus Inversion to Reduce IR Drop

Various embodiments include techniques for reducing IR drop in an electronic circuit. With the disclosed techniques, a signal interconnect transmitter receives a set of electronic signals, also referred to as signals, included in an interconnect from one or more source components. The transmitter divides the set of signals included in the interconnect into groups, such as into two groups that include approximately one-half of the signals included in the interconnect. The transmitter staggers the signals included in the interconnect such that the signals in one of the two groups transition on the positive (rising) edge of the clock signal and the signals in the other of the two groups transition on the negative (falling) edge of the clock signal. Further, the transmitter applies data bus inversion (DBI) to the signals included in the interconnect. The transmitter can stagger the signals either before or after applying DBI to the signals included in the interconnect.

One or more dual edge DBI retiming circuits carry the signals from the transmitter to a signal interconnect receiver. The dual edge DBI retiming circuits continue to transition one group of signals on the positive edge of the clock signal and the other group of signals on the negative edge of the clock signal. The dual edge DBI retiming circuits thereby maintain the staggering of the signal transitions applied by the transmitter. A signal interconnect receiver realigns the groups of signals to transition on the same edge of the clock signal, such as the positive edge of the clock signal. The receiver joins the groups of signals into a single interconnect. The receiver transmits the signals in the joined interconnect to one or more destination components.

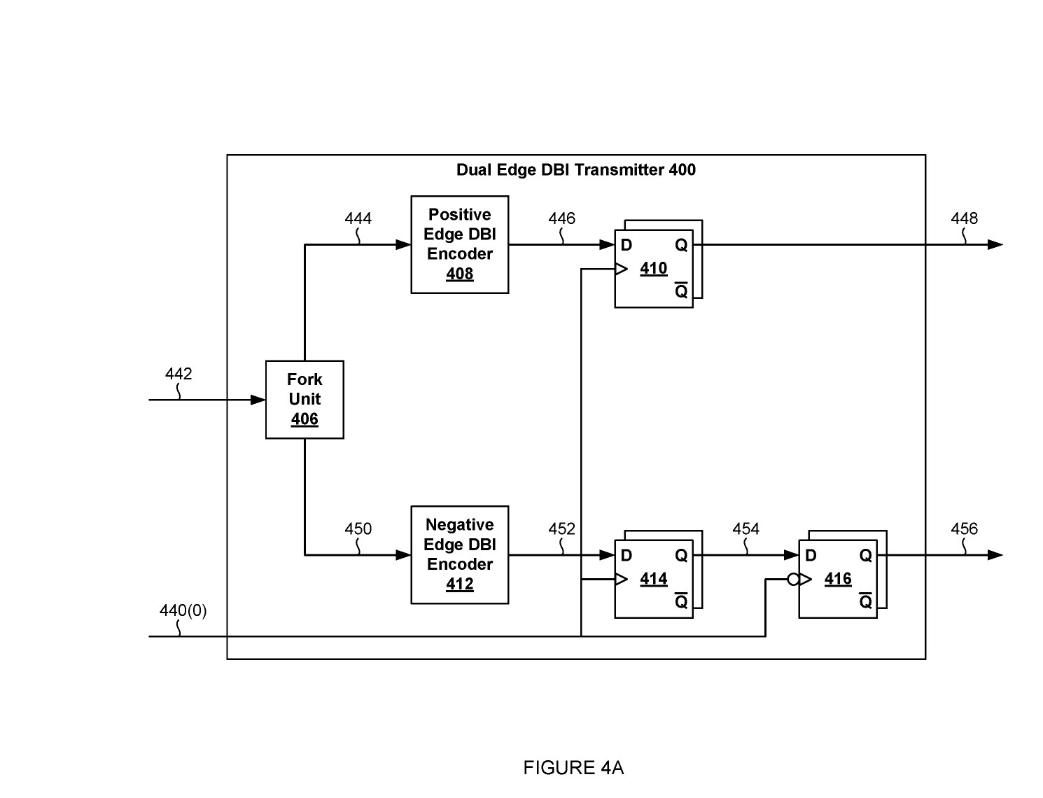

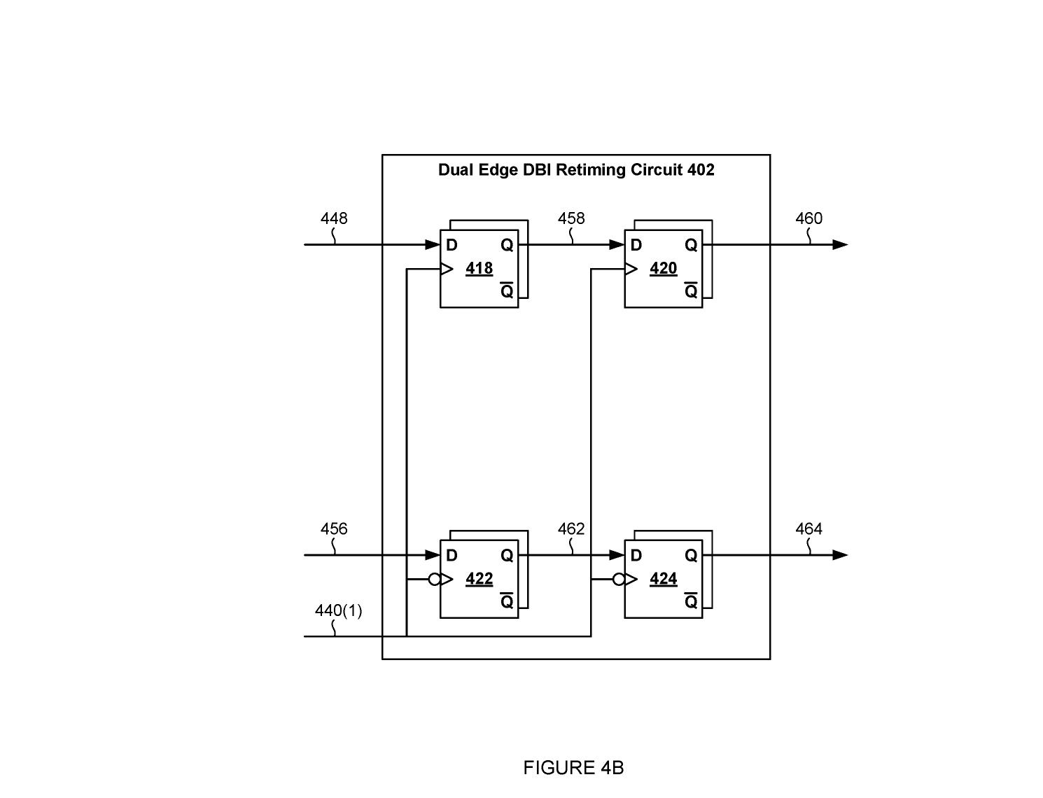

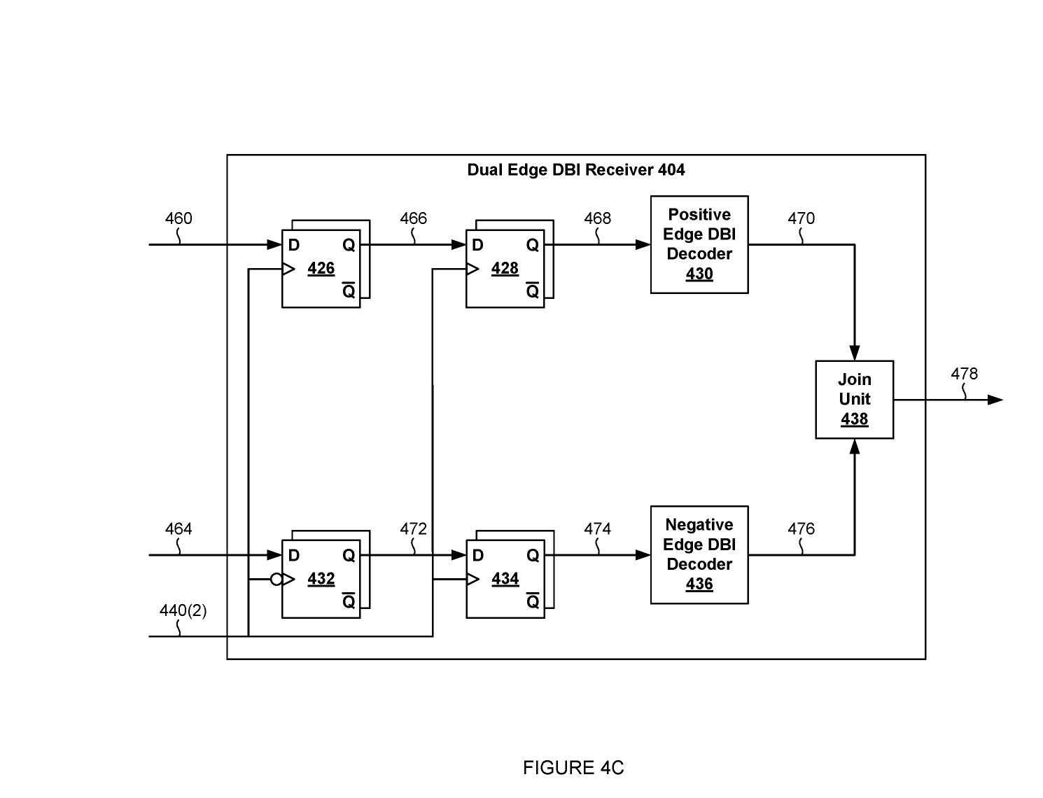

FIGS. 4A-4C set forth a block diagram of a dual edge data bus inversion (DBI) system for transmitting signals for an interconnect included in the computing system 100 of FIGS. 1-3, according to various embodiments. The dual edge DBI system includes, without limitation, a dual edge DBI transmitter 400, a dual edge DBI retiming circuit 402, and a dual edge DBI receiver 404. The dual edge DBI system can be applied to any interconnect in computing system 100, where an interconnect can be any set of signals that are transmitted by and/or received by any set of components included in computing system 100. In some embodiments, the interconnect can be a data bus and/or an address bus between two or more of CPU 102, parallel processing subsystem 112, system memory 104, PP memory 204, and/or the like. Additionally or alternatively, the interconnect can be any set of signals that connect two or more components included in computing system 100.

As shown in FIG. 4A, dual edge DBI transmitter 400 includes, without limitation, a fork unit 406, a positive edge DBI encoder 408, a negative edge DBI encoder 412, and flip-flops 410, 414, and 416. Flip-flops 410, 414, and 416 receive a synchronizing clock signal 440(0), also referred to as a clock signal.

Fork unit 406 receives a set of signals from one or more source components via signal path 442. The signals include an interconnect, such as a data bus, an address bus, and/or other signals, that connect components in computing system 100. The signals further include a valid signal that varies between a first voltage level representing a logic FALSE value and a second voltage level representing a logic TRUE value. When the valid signal is at a logic FALSE value, the signals of the interconnect are not valid. Therefore, fork unit 406 and other components of dual edge DBI transmitter 400 do not process the signals of the interconnect. When the valid signal is at a logic TRUE value, the signals of the interconnect are valid. Therefore, fork unit 406 and other components of dual edge DBI transmitter 400 process the signals of the interconnect.

Fork unit 406 processes valid signals of the interconnect by dividing into groups of substantially the same size. In some embodiments, the interconnect includes an even number of signals, such as a data bus that includes 32 data bits, 64 data bits, 128 data bits, and/or the like. Fork unit 406 can divide the signals into two groups of equal size, such as two groups of 16 data bits, two groups of 32 bits, two groups of 64 bits, and/or the like. If the interconnect includes an odd number of signals, such as a set of 127 data bits, fork unit 406 can divide the signals into two groups of substantially equal size, such as a first group of 64 data bits and a second first group of 63 data bits.

Fork unit can 406 divide the valid signals of the interconnect in any technically feasible manner. For example, the interconnect can be a data bus, address bus, or other group of related signals that are consecutively numbered. In one example, the interconnect can be a 128-bit data bus with signal identified as data, data, data, . . . data[0]. Fork unit 406 can divide such an interconnect into a first group of 64 most significant bits (data:data) and a second first group of 64 least significant bits (data:data[0]). Alternatively, fork unit 406 can divide such an interconnect into a first group of 64 even numbered bits (data, data, data, . . . data[0]) and a second group of 64 odd numbered bits (data, data, data, . . . data[1]). Alternatively, fork unit 406 can divide such an interconnect into two groups of 64 signals, where the signals in each group are routed in close proximity to one another on an integrated circuit, a substrate, a printed circuit board, and/or the like.

Fork unit 406 transmits the first group of signals and a first copy of the valid signal to positive edge DBI encoder 408 via signal path 444. The first group of signals is referred to as the positive edge signal group and the first copy of the valid signal is referred to as the positive edge valid signal. Positive edge DBI encoder 408 generates a DBI encoded version of the positive edge signal group. When the positive edge valid signal is at a logic TRUE value, positive edge DBI encoder 408 applies data bus inversion to the positive edge signal group. To apply data bus inversion, positive edge DBI encoder 408 compares the currently valid signals of the positive edge signal group with the preceding valid signals of the positive edge signal group. Positive edge DBI encoder 408 determines whether, when changing from the preceding valid signals to the currently valid signals, more than 50% of the signals change logic levels. If the percentage of signals that change logic levels is less than or equal to 50%, then positive edge DBI encoder 408 transmits the currently valid signals as is. If, however, the percentage of signals that change logic levels is more than 50%, then positive edge DBI encoder 408 inverts the logic levels of the currently valid signals and then transmits the inversion of the currently valid signals. Because the percentage of signals that change logic levels from the preceding valid signals to the currently valid signals is more than 50%, the percentage of signals that change logic levels from the preceding valid signals to the inversion of the currently valid signals is less than 50%. As a result, selective data bus inversion results in a maximum of 50% transitioning between successive valid signal transmissions from positive edge DBI encoder 408.

Further, positive edge DBI encoder 408 generates a positive edge DBI signal that is at a logic FALSE value when transmitting the currently valid signals as is and a logic TRUE value when transmitting the inversion of the currently valid signals. Positive edge DBI encoder 408 can apply data bus inversion to the positive edge signal group as a single group. When applying data bus inversion to the positive edge signal group as a single group, positive edge DBI encoder 408 generates a positive edge DBI signal for the entire positive edge signal group. Additionally or alternatively, positive edge DBI encoder 408 can divide the positive edge signal group into multiple subgroups and separately apply data bus inversion to each subgroup of the positive edge signal group. When applying data bus inversion to the positive edge signal group as multiple subgroups, positive edge DBI encoder 408 generates a positive edge DBI signal for each subgroup in the positive edge signal group. For example, if positive edge DBI encoder 408 divides the positive edge signal group into two subgroups, then positive edge DBI encoder 408 independently applies data bus inversion to each of the two subgroups. Positive edge DBI encoder 408 generates two independent positive edge DBI signals, one positive edge DBI signal for each subgroup.

Positive edge DBI encoder 408 transmits the DBI encoded positive edge signal group, the positive edge valid signal, and the positive edge DBI signal(s) to flip-flop 410 via signal path 446. Flip-flop 410 samples the DBI encoded positive edge signal group, the positive edge valid signal, and the positive edge DBI signal(s) on the positive edge of clock signal 440(0). As a result, the output of flip-flop 410 transmits a copy of the DBI encoded positive edge signal group, the positive edge valid signal, and the positive edge DBI signal(s) that are synchronized to the positive edge of clock signal 440(0). Flip-flop 410 transmits the synchronized copy of these signals to flip-flop 418 of dual edge DBI retiming circuit 402 via signal path 448.

Similarly, fork unit 406 transmits the second group of signals and a second copy of the valid signal to negative edge DBI encoder 412 via signal path 450. The second group of signals is referred to as the negative edge signal group and the second copy of the valid signal is referred to as the negative edge valid signal. Negative edge DBI encoder 412 generates a DBI encoded version of the negative edge signal group. When the negative edge valid signal is at a logic TRUE value, negative edge DBI encoder 412 applies data bus inversion to the negative edge signal group. To apply data bus inversion, negative edge DBI encoder 412 compares the currently valid signals of the negative edge signal group with the preceding valid signals of the negative edge signal group. Negative edge DBI encoder 412 determines whether, when changing from the preceding valid signals to the currently valid signals, more than 50% of the signals change logic levels. If the percentage of signals that change logic levels is less than or equal to 50%, then negative edge DBI encoder 412 transmits the currently valid signals as is. If, however, the percentage of signals that change logic levels is more than 50%, then negative edge DBI encoder 412 inverts the logic levels of the currently valid signals and then transmits the inversion of the currently valid signals. Because the percentage of signals that change logic levels from the preceding valid signals to the currently valid signals is more than 50%, the percentage of signals that change logic levels from the preceding valid signals to the inversion of the currently valid signals is less than 50%. As a result, selective data bus inversion results in a maximum of 50% transitioning between successive valid signal transmissions from negative edge DBI encoder 412.

Further, negative edge DBI encoder 412 generates a negative edge DBI signal that is at a logic FALSE value when transmitting the currently valid signals as is and a logic TRUE value when transmitting the inversion of the currently valid signals. Negative edge DBI encoder 412 can apply data bus inversion to the negative edge signal group as a single group. When applying data bus inversion to the negative edge signal group as a single group, negative edge DBI encoder 412 generates a negative edge DBI signal for the entire negative edge signal group. Additionally or alternatively, negative edge DBI encoder 412 can divide the negative edge signal group into multiple subgroups and separately apply data bus inversion to each subgroup of the negative edge signal group. When applying data bus inversion to the negative edge signal group as multiple subgroups, negative edge DBI encoder 412 generates a negative edge DBI signal for each subgroup in the negative edge signal group. For example, if negative edge DBI encoder 412 divides the negative edge signal group into two subgroups, then negative edge DBI encoder 412 independently applies data bus inversion to each of the two subgroups. Negative edge DBI encoder 412 generates two independent negative edge DBI signals, one negative edge DBI signal for each subgroup.

Negative edge DBI encoder 412 transmits the DBI encoded negative edge signal group, the negative edge valid signal, and the negative edge DBI signal(s) to flip-flop 414 via signal path 452. Flip-flop 414 samples the DBI encoded negative edge signal group, the negative edge valid signal, and the negative edge DBI signal(s) on the positive edge of clock signal 440(0). As a result, the output of flip-flop 414 transmits a copy of the DBI encoded negative edge signal group, the negative edge valid signal, and the negative edge DBI signal(s) that are synchronized to the positive edge of clock signal 440(0). Flip-flop 414 transmits the synchronized copy of these signals to flip-flop 416 via signal path 454.

Flip-flop 416 samples signals received from flip-flop 414 on the negative edge of clock signal 440(0). As a result, the output of flip-flop 416 transmits a copy of the DBI encoded negative edge signal group, the negative edge valid signal, and the negative edge DBI signal(s) that are synchronized to the negative edge of clock signal 440(0). Flip-flop 416 transmits the synchronized copy of these signals to flip-flop 422 of dual edge DBI retiming circuit 402 via signal path 456.

Because the outputs of flip-flop 410 and flip-flop 416 transition at opposite edges of clock signal 440(0), a maximum of 50% of the full set of signals in the interconnect can transition at each edge of clock signal 440(0). Further, because data bus inversion has been applied to the signals transmitted by flip-flop 410, a maximum of 50% of the signals transmitted by flip-flop 410 can transition at the positive edge of clock signal 440(0). Similarly, because data bus inversion has also been applied to the signals transmitted by flip-flop 416, a maximum of 50% of the signals transmitted by flip-flop 416 can transition at the negative edge of clock signal 440(0). Consequently, a maximum of 25% of the signals transmitted by flip-flops 410 and 416 can transition at each edge of clock signal 420(0).

As shown in FIG. 4B, dual edge DBI retiming circuit 402 includes, without limitation, flip-flops 418, 420, 422, and 424. Flip-flops 418, 420, 422, and 424 receive a synchronizing clock signal 440(1), also referred to as a clock signal. Clock signal 440(1) can be the same clock signal as clock signal 440(0), a copy of clock signal 440(0), a clock signal that is synchronous with clock signal 440(0), and/or the like. If dual edge DBI transmitter 400 and dual edge DBI receiver 404 are located sufficiently far away from one another, the signals transmitted by dual edge DBI transmitter 400 can become delayed with respect to one another, which can lead to phase errors and/or data bit errors when the signals are received at dual edge DBI receiver 404. To address these issues, the signals can be retimed, or resynchronized, by one or more sets of retiming flip-flops. As shown, signals transmitted by flip-flop 410 in dual edge DBI transmitter 400 via signal path 448 can be retimed to the positive edge of clock signal 440(1) by flip-flop 418. Similarly, signals transmitted by flip-flop 416 in dual edge DBI transmitter 400 via signal path 456 can be retimed to the negative edge of clock signal 440(1) by flip-flop 422.

If the distance between dual edge DBI transmitter 400 and dual edge DBI receiver 404 is significantly long, additional pairs of retiming flip-flops can be added to dual edge DBI retiming circuit 402 as needed. In that regard, signals transmitted by flip-flop 418 via signal path 458 can be retimed to the positive edge of clock signal 440(1) by flip-flop 420. Flip-flop 420, in turn, transmits the retimed signals to flip-flop 426 in dual edge DBI receiver 404 via signal path 460. Similarly, signals transmitted by flip-flop 422 via signal path 462 can be retimed to the negative edge of clock signal 440(1) by flip-flop 424. Flip-flop 424, in turn, transmits the retimed signals to flip-flop 432 in dual edge DBI receiver 404 via signal path 464.

As shown in FIG. 4C, dual edge DBI receiver 404 includes flip-flops 426, 428, 432, and 434, a positive edge DBI decoder 430, a negative edge DBI decoder 436, and a join unit 438. Flip-flops 426, 428, 432, and 434 receive a synchronizing clock signal 440(2), also referred to as a clock signal. Clock signal 440(2) can be the same clock signal as one or more of clock signals 440(0) and 440(1), a copy of one or more of clock signals 440(0) and 440(1), a clock signal that is synchronous with one or more of clock signals 440(0) and 440(1), and/or the like.

Flip-flop 426 retimes the signals received from flip-flop 420 of dual edge DBI retiming circuit 402 via signal path 460. Flip-flop 426 retimes the signals to the positive edge of clock signal 440(2). Flip-flop 426 transmits the retimed signals to flip-flop 428 via signal path 466. Flip-flop 428 is a latency matching flip-flop to match the delay of the positive edge signals at the output of flip-flop 428 with the delay of the negative edge signals at the output of flip-flop 434. Flip-flop 428 retimes the signals to the positive edge of clock signal 440(2).

Similarly, flip-flop 432 retimes the signals received from flip-flop 424 of dual edge DBI retiming circuit 402 via signal path 464. Flip-flop 432 retimes the signals to the negative edge of clock signal 440(2). Flip-flop 432 transmits the retimed signals to flip-flop 434 via signal path 472. Flip-flop 434 retimes the signals to the positive edge of clock signal 440(2). As a result, the outputs of flip-flop 428 and flip-flop 434 are aligned with one another and synchronized to the positive edge of clock signal 440(2).

Flip-flop 428 transmits signals to positive edge DBI decoder 430 via signal path 468. The signals include the DBI encoded positive edge signal group, the positive edge valid signal, and the positive edge DBI signal(s). When positive edge DBI decoder 430 detects that the positive edge valid signal is at a logic TRUE value, positive edge DBI decoder 430 processes the DBI encoded positive edge signal group to reverse the data bus inversion applied by positive edge DBI encoder 408 in dual edge DBI transmitter 400. To do so, positive edge DBI decoder 430 determines whether a positive edge DBI signal is at a logic FALSE value or at a logic TRUE value. If the positive edge DBI signal is at a logic FALSE value, then positive edge DBI decoder 430 transmits DBI encoded positive edge signal group as is. If, however, the positive edge DBI signal is at a logic TRUE value, then positive edge DBI decoder 430 inverts the DBI encoded positive edge signal group and then transmits the inverted DBI encoded positive edge signal group. As discussed in conjunction with positive edge DBI encoder 408, positive edge DBI decoder 430 can reverse data bus inversion for the DBI encoded positive edge signal group as a single group or as two or more individual subgroups. Positive edge DBI decoder 430 transmits the processed positive edge signal group to join unit 438 via signal path 470.

Similarly, flip-flop 434 transmits signals to negative edge DBI decoder 436 via signal path 474. The signals include the DBI encoded negative edge signal group, the negative edge valid signal, and the negative edge DBI signal(s). When negative edge DBI decoder 436 detects that the negative edge valid signal is at a logic TRUE value, negative edge DBI decoder 436 processes the DBI encoded negative edge signal group to reverse the data bus inversion applied by negative edge DBI encoder 412 in dual edge DBI transmitter 400. To do so, negative edge DBI decoder 436 determines whether a negative edge DBI signal is at a logic FALSE value or at a logic TRUE value. If the negative edge DBI signal is at a logic FALSE value, then negative edge DBI decoder 436 transmits DBI encoded negative edge signal group as is. If, however, the negative edge DBI signal is at a logic TRUE value, then negative edge DBI decoder 436 inverts the DBI encoded negative edge signal group and then transmits the inverted DBI encoded negative edge signal group. As discussed in conjunction with negative edge DBI encoder 412, negative edge DBI decoder 436 can reverse data bus inversion for the DBI encoded negative edge signal group as a single group or as two or more individual subgroups. Negative edge DBI decoder 436 transmits the processed negative edge signal group to join unit 438 via signal path 476.

Join unit 438 joins the processed positive edge signal group received from positive edge DBI decoder 430 via signal path 470 with the processed negative edge signal group received from negative edge DBI decoder 436 via signal path 476. After joining the two signal groups, join unit 438 transmits a copy of the original signals of the interconnect received by fork unit 406 of dual edge DBI transmitter 400. Join unit 438 transmits the copy of the original signals of the interconnect to one or more destination components via signal path 478.

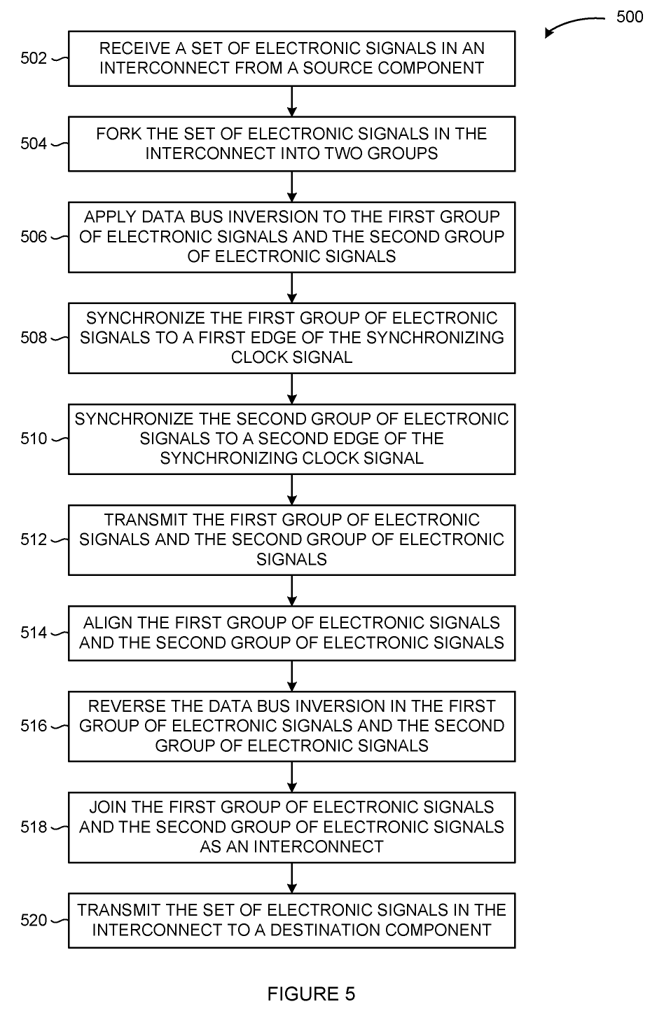

FIG. 5 is a flow diagram of method steps for transmitting electronic signals for an interconnect with the dual edge DBI system of FIGS. 4A-4C, according to various embodiments. Additionally or alternatively, the method steps can be performed by one or more alternative components associates with one or more processors including, without limitation, microcontrollers, RISC processors, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-4C, persons of ordinary skill in the art will understand that any system configured to perform the method steps, in any order, is within the scope of the present disclosure.

As shown, a method 500 begins at step 502, where dual edge DBI transmitter 400 receives a set of electronic signals in an interconnect from a source component. The signals include an interconnect, such as a data bus, an address bus, and/or other signals, that connect components in computing system 100. The signals further include a valid signal that is at a logic FALSE value when the signals of the interconnect are not valid and at a logic TRUE value when the signals of the interconnect are valid. Dual edge DBI transmitter 400 processes the signals of the interconnect when the valid signal is at a logic TRUE value and does not process the signals of the interconnect when the valid signal is at a logic FALSE value

At step 504, dual edge DBI transmitter 400 forks, or divides, the set of electronic signals in the interconnect into two groups. Dual edge DBI transmitter 400 can divide an interconnect of 128 bits into a first group of 64 most significant bits and a second first group of 64 least significant bits. Alternatively, dual edge DBI transmitter 400 can divide the interconnect into a first group of 64 even numbered bits and a second group of 64 odd numbered bits. Alternatively, dual edge DBI transmitter 400 can divide the interconnect into two groups of 64 signals, where the signals in each group are routed in close proximity to one another on an integrated circuit, a substrate, a printed circuit board, and/or the like.

At step 506, dual edge DBI transmitter 400 applies data bus inversion to the first group of electronic signals and the second group of electronic signals. Dual edge DBI transmitter 400 applies data bus inversion to the first group of electronic signals by comparing the currently valid signals of the first group of electronic signals with the preceding valid signals of the first group of electronic signals. Dual edge DBI transmitter 400 determines whether, when changing from the preceding valid signals to the currently valid signals, more than 50% of the signals change logic levels. If the percentage of signals that change logic levels is less than or equal to 50%, then dual edge DBI transmitter 400 transmits the currently valid first group of electronic signals as is. If, however, the percentage of signals that change logic levels is more than 50%, then positive edge DBI encoder 408 inverts the logic levels of the currently valid first group of electronic signals and then transmits the inversion of the currently valid first group of electronic signals.

Similarly, dual edge DBI transmitter 400 applies data bus inversion to the second group of electronic signals by comparing the currently valid signals of the second group of electronic signals with the preceding valid signals of the second group of electronic signals. Dual edge DBI transmitter 400 determines whether, when changing from the preceding valid signals to the currently valid signals, more than 50% of the signals change logic levels. If the percentage of signals that change logic levels is less than or equal to 50%, then dual edge DBI transmitter 400 transmits the currently valid second group of electronic signals as is. If, however, the percentage of signals that change logic levels is more than 50%, then positive edge DBI encoder 408 inverts the logic levels of the currently valid second group of electronic signals and then transmits the inversion of the currently valid second group of electronic signals.

At step 508, dual edge DBI transmitter 400 synchronizes the first group of electronic signals to a first edge of a synchronizing clock signal. For example, dual edge DBI transmitter 400 can sample the DBI encoded positive edge signal group, the positive edge valid signal, and the positive edge DBI signal(s) on the positive edge of the synchronizing clock signal.

At step 510, dual edge DBI transmitter 400 synchronizes the second group of electronic signals to a second edge of the synchronizing clock signal. For example, dual edge DBI transmitter 400 can sample the DBI encoded negative edge signal group, the negative edge valid signal, and the negative edge DBI signal(s) on the negative edge of the synchronizing clock signal.

At step 512, dual edge DBI transmitter 400 transmits the first group of electronic signals and the second group of electronic signals. Dual edge DBI transmitter 400 transmits the first group of electronic signals, namely, the DBI encoded positive edge signal group, the positive edge valid signal, and the positive edge DBI signal(s), that are synchronized to the positive edge of the synchronizing clock signal. Further, dual edge DBI transmitter 400 transmits the second group of electronic signals, namely, the DBI encoded negative edge signal group, the negative edge valid signal, and the negative edge DBI signal(s), that are synchronized to the negative edge of the synchronizing clock signal.

As the signals propagate from the output of dual edge DBI transmitter 400 to the input of dual edge DBI receiver 404, dual edge DBI retiming circuit 402 can retime the signals to respective edges of the synchronizing clock signal. More specifically, dual edge DBI retiming circuit 402 can retime the first group of electronic signals, namely the DBI encoded positive edge signal group, the positive edge valid signal, and the positive edge DBI signal(s), to the positive edge of the synchronizing clock signal. Further, dual edge DBI retiming circuit 402 can retime the second group of electronic signals, namely, the DBI encoded negative edge signal group, the negative edge valid signal, and the negative edge DBI signal(s), to the negative edge of the synchronizing clock signal.

At step 514, dual edge DBI receiver 404 aligns the first group of electronic signals and the second group of electronic signals. Dual edge DBI receiver 404 retimes the first group of electronic signals received from dual edge DBI retiming circuit 402 to the positive edge of the synchronizing clock signal. Further, dual edge DBI receiver 404 performs latency matching flip-flop to match the delay of the first group of electronic signals with the delay of the second group of electronic signals.

Similarly, dual edge DBI receiver 404 retimes the second group of electronic signals received from dual edge DBI retiming circuit 402 to the negative edge of the synchronizing clock signal. Dual edge DBI receiver 404 then retimes the signals to the positive edge of the synchronizing clock signal. As a result, the first group of electronic signals and the second group of electronic signals are aligned with one another and synchronized to the positive edge of the synchronizing clock signal.

At step 516, dual edge DBI receiver 404 reverses the data bus inversion in the first group of electronic signals and the second group of electronic signals.

The first group of electronic signals includes the DBI encoded positive edge signal group, the positive edge valid signal, and the positive edge DBI signal(s). When dual edge DBI receiver 404 detects that the positive edge valid signal is at a logic TRUE value, dual edge DBI receiver 404 processes the DBI encoded positive edge signal group to reverse the data bus inversion applied by dual edge DBI transmitter 400. To do so, dual edge DBI receiver 404 determines whether a positive edge DBI signal is at a logic FALSE value or at a logic TRUE value. If the positive edge DBI signal is at a logic FALSE value, then dual edge DBI receiver 404 transmits DBI encoded positive edge signal group as is. If, however, the positive edge DBI signal is at a logic TRUE value, then dual edge DBI receiver 404 inverts the DBI encoded positive edge signal group and then transmits the inverted DBI encoded positive edge signal group.

Similarly, the second group of electronic signals includes the DBI encoded negative edge signal group, the negative edge valid signal, and the positive edge DBI signal(s). When dual edge DBI receiver 404 detects that the negative edge valid signal is at a logic TRUE value, dual edge DBI receiver 404 processes the DBI encoded negative edge signal group to reverse the data bus inversion applied by dual edge DBI transmitter 400. To do so, dual edge DBI receiver 404 determines whether a negative edge DBI signal is at a logic FALSE value or at a logic TRUE value. If the negative edge DBI signal is at a logic FALSE value, then dual edge DBI receiver 404 transmits DBI encoded negative edge signal group as is. If, however, the negative edge DBI signal is at a logic TRUE value, then dual edge DBI receiver 404 inverts the DBI encoded negative edge signal group and then transmits the inverted DBI encoded negative edge signal group.

At step 518, dual edge DBI receiver 404 joins the first group of electronic signals and the second group of electronic signals into a copy of the original interconnect. Dual edge DBI receiver 404 joins the processed first group of electronic signals after positive edge DBI decoding with the processed second group of electronic signals after negative edge DBI decoding.

At step 520, dual edge DBI receiver 404 transmits the electronic signals in the interconnect to a destination component. After joining the two signal groups, dual edge DBI receiver 404 transmits a copy of the original signals of the interconnect received by dual edge DBI transmitter 400. Dual edge DBI receiver 404 transmits the copy of the original signals of the interconnect to one or more destination components.

The method 500 then terminates. Alternatively, the method 500 returns to step 502 to process additional electronic signals received via the interconnect.

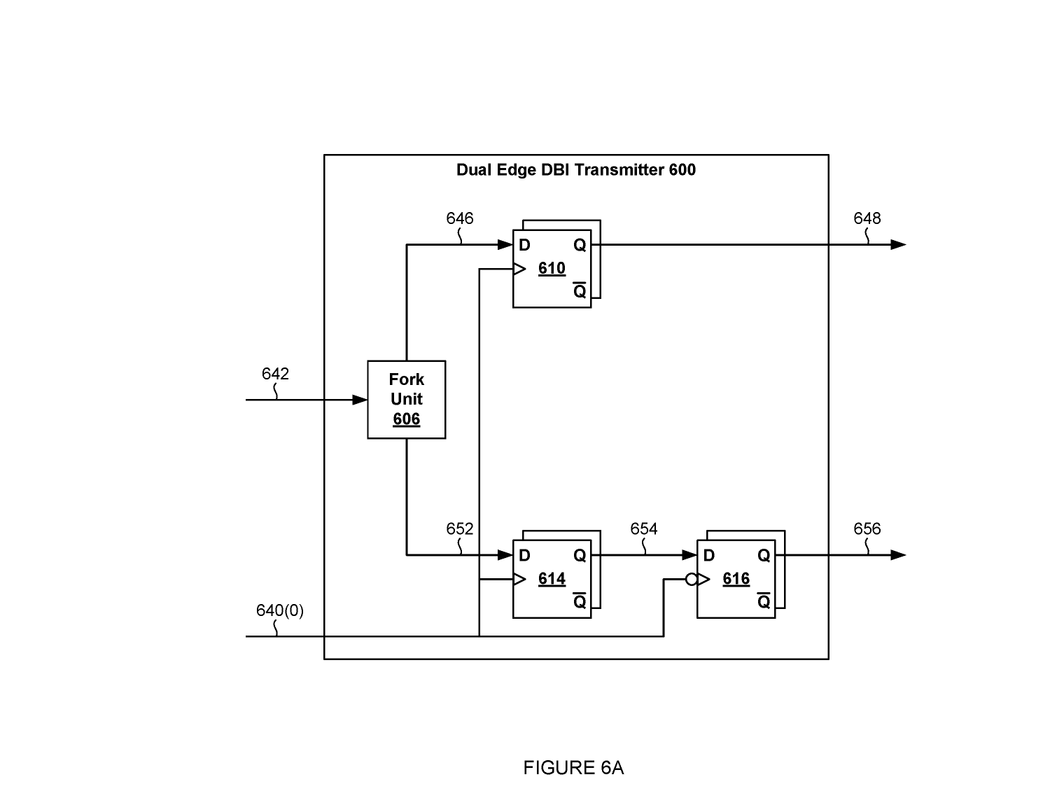

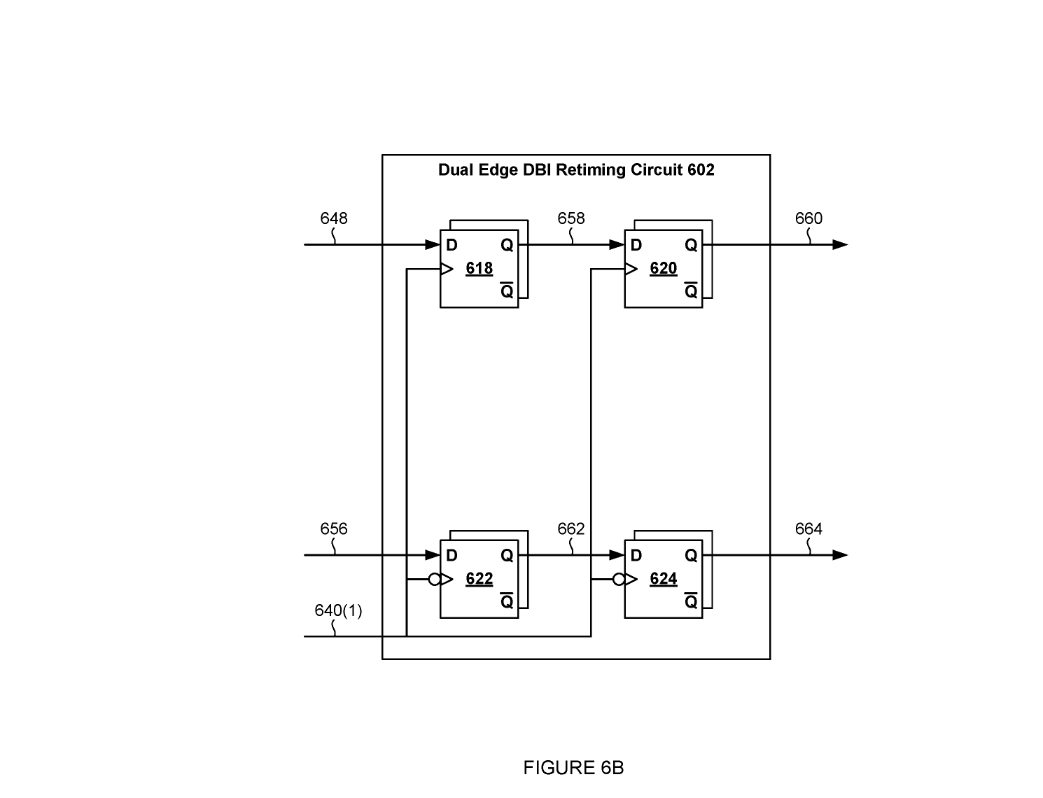

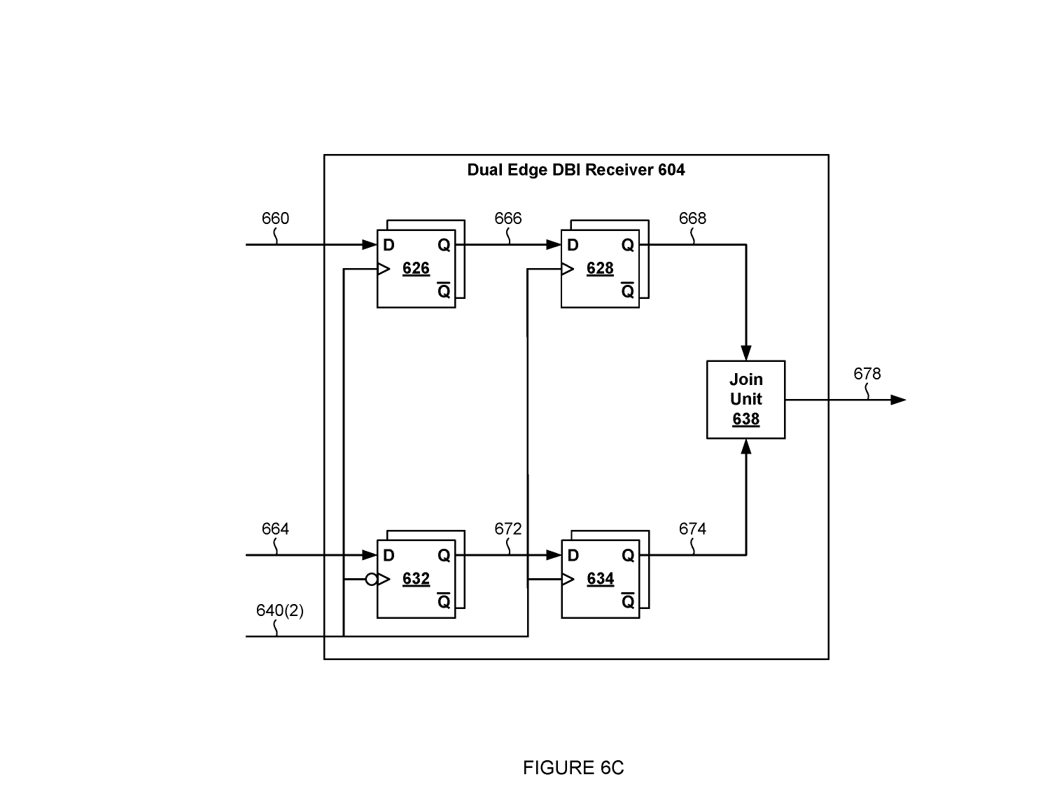

FIGS. 6A-6C set forth a block diagram of a dual edge DBI system with an external DBI encoder and an external DBI decoder for transmitting electronic signals for an interconnect included in the computing system of FIGS. 1-3, according to various embodiments. The dual edge DBI system includes, without limitation, a dual edge DBI transmitter 600, a dual edge DBI retiming circuit 602, and a dual edge DBI receiver 604. The dual edge DBI system can be applied to any interconnect in computing system 100, where an interconnect can be any set of signals that are transmitted by and/or received by any set of components included in computing system 100. In some embodiments, the interconnect can be a data bus and/or an address bus between two or more of CPU 102, parallel processing subsystem 112, system memory 104, PP memory 204, and/or the like. Additionally or alternatively, the interconnect can be any set of signals that connect two or more components included in computing system 100.

As shown in FIG. 6A, dual edge DBI transmitter 600 includes, without limitation, a fork unit 606 and flip-flops 610, 614, and 616. Flip-flops 610, 614, and 616 receive a synchronizing clock signal 640(0), also referred to as a clock signal.

Fork unit 606 receives a set of signals from one or more source components via signal path 642. The signals include an interconnect, such as a data bus, an address bus, and/or other signals, that connect components in computing system 100. The signals included in the interconnect are DBI encoded prior to being received by fork unit 606. The signals further include a valid signal that varies between a first voltage level representing a logic FALSE value and a second voltage level representing a logic TRUE value. When the valid signal is at a logic FALSE value, the signals of the interconnect are not valid. Therefore, fork unit 606 and other components of dual edge DBI transmitter 600 do not process the signals of the interconnect. When the valid signal is at a logic TRUE value, the signals of the interconnect are valid. Therefore, fork unit 606 and other components of dual edge DBI transmitter 600 process the signals of the interconnect.

The signals further include one or more DBI signals associated with the interconnect. The DBI signals are generated prior to being received by dual edge DBI transmitter 600. A DBI signal is at a logic FALSE value when the corresponding signals of the interconnect have not been inverted and a logic TRUE value when the corresponding signals of the interconnect have been inverted. The signals can include a single DBI signal for the entire set of signals in the interconnect. Additionally or alternatively, the signals can include multiple DBI signals, where each DBI signal corresponds to a different subgroup of signals in the interconnect.

Fork unit 606 processes valid signals of the interconnect by dividing the signals into the same groups that were used for generating the DBI signals. In one example, the interconnect can include two groups and two DBI signals. Each DBI signal corresponds one of the two groups. Fork unit 606 can divide the signals into a first group that includes the DBI signal for the first group and a second group that includes the DBI signal for the second group. In another example, the interconnect can include four subgroups and four DBI signals. Each DBI signal corresponds one of the four subgroups. Fork unit 606 can divide the signals into a first group that includes two of the subgroups and the two DBI signals for those two subgroups and a second group that includes the other two of the subgroups and the two DBI signals for those other two subgroups.

Fork unit 606 can divide the valid signals of the interconnect in any technically feasible manner. For example, the interconnect can be a data bus, address bus, or other group of related signals that are consecutively numbered. In one example, the interconnect can be a 128-bit data bus with signal identified as data, data, data, . . . data[0]. Fork unit 606 can divide such an interconnect into a first group of 64 most significant bits (data:data) and a second first group of 64 least significant bits (data:data[0]). Alternatively, fork unit 606 can divide such an interconnect into a first group of 64 even numbered bits (data, data, data, . . . data[0]) and a second group of 64 odd numbered bits (data, data, data, . . . data[1]). Alternatively, fork unit 606 can divide such an interconnect into two groups of 64 signals, where the signals in each group are routed in close proximity to one another on an integrated circuit, a substrate, a printed circuit board, and/or the like.

Fork unit 606 transmits the first group of signals, the corresponding DBI signals, and a first copy of the valid signal to flip-flop 610 via signal path 646. The first group of signals is referred to as the positive edge signal group, the corresponding DBI signals are referred to as the positive edge DBI signals, and the first copy of the valid signal is referred to as the positive edge valid signal. Flip-flop 610 samples the positive edge signal group, the positive edge valid signal, and the positive edge DBI signal(s) on the positive edge of clock signal 640(0). As a result, the output of flip-flop 610 transmits a copy of the positive edge signal group, the positive edge valid signal, and the positive edge DBI signal(s) that are synchronized to the positive edge of clock signal 640(0). Flip-flop 610 transmits the synchronized copy of these signals to flip-flop 618 of dual edge DBI retiming circuit 602 via signal path 648.

Similarly, fork unit 606 transmits the second group of signals, the corresponding DBI signals, and a second copy of the valid signal to flip-flop 614 via signal path 652. The second group of signals is referred to as the negative edge signal group, the corresponding DBI signals are referred to as the negative edge DBI signals, and the second copy of the valid signal is referred to as the negative edge valid signal. Flip-flop 614 samples the negative edge signal group, the negative edge valid signal, and the negative edge DBI signal(s) on the positive edge of clock signal 640(0). As a result, the output of flip-flop 614 transmits a copy of the negative edge signal group, the negative edge valid signal, and the negative edge DBI signal(s) that are synchronized to the positive edge of clock signal 640(0). Flip-flop 614 transmits the synchronized copy of these signals to flip-flop 616 via signal path 654.

Flip-flop 616 samples signals received from flip-flop 614 on the negative edge of clock signal 640(0). As a result, the output of flip-flop 616 transmits a copy of the negative edge signal group, the negative edge valid signal, and the negative edge DBI signal(s) that are synchronized to the negative edge of clock signal 640(0). Flip-flop 616 transmits the synchronized copy of these signals to flip-flop 622 of dual edge DBI retiming circuit 602 via signal path 656.

Because the outputs of flip-flop 610 and flip-flop 616 transition at opposite edges of clock signal 640(0), a maximum of 50% of the full set of signals in the interconnect can transition at each edge of clock signal 640(0). Further, because data bus inversion has been previously applied to the signals received by fork unit 606 and transmitted by flip-flop 610, a maximum of 50% of the signals transmitted by flip-flop 610 can transition at the positive edge of clock signal 640(0). Similarly, because data bus inversion has also been previously applied to the signals received by fork unit 606 and transmitted by flip-flops 614 and 616, a maximum of 50% of the signals transmitted by flip-flop 616 can transition at the negative edge of clock signal 640(0). Consequently, a maximum of 25% of the signals transmitted by flip-flops 610 and 616 can transition at each edge of clock signal 620(0).

As shown in FIG. 6B, dual edge DBI retiming circuit 602 includes, without limitation, flip-flops 618, 620, 622, and 624. Flip-flops 618, 620, 622, and 624 receive a synchronizing clock signal 640(1), also referred to as a clock signal. Clock signal 640(1) can be the same clock signal as clock signal 640(0), a copy of clock signal 640(0), a clock signal that is synchronous with clock signal 640(0), and/or the like. If dual edge DBI transmitter 600 and dual edge DBI receiver 604 are located sufficiently far away from one another, the signals transmitted by dual edge DBI transmitter 600 can become delayed with respect to one another, which can lead to phase errors and/or data bit errors when the signals are received at dual edge DBI receiver 604. To address these issues, the signals can be retimed, or resynchronized, by one or more sets of retiming flip-flops. As shown, signals transmitted by flip-flop 610 in dual edge DBI transmitter 600 via signal path 648 can be retimed to the positive edge of clock signal 640(1) by flip-flop 618. Similarly, signals transmitted by flip-flop 616 in dual edge DBI transmitter 600 via signal path 656 can be retimed to the negative edge of clock signal 640(1) by flip-flop 622.

If the distance between dual edge DBI transmitter 600 and dual edge DBI receiver 604 is significantly long, additional pairs of retiming flip-flops can be added to dual edge DBI retiming circuit 602 as needed. In that regard, signals transmitted by flip-flop 618 via signal path 658 can be retimed to the positive edge of clock signal 640(1) by flip-flop 620. Flip-flop 620, in turn, transmits the retimed signals to flip-flop 626 in dual edge DBI receiver 604 via signal path 660. Similarly, signals transmitted by flip-flop 622 via signal path 662 can be retimed to the negative edge of clock signal 640(1) by flip-flop 624. Flip-flop 624, in turn, transmits the retimed signals to flip-flop 632 in dual edge DBI receiver 604 via signal path 664.

As shown in FIG. 6C, dual edge DBI receiver 604 includes flip-flops 626, 628, 632, and 634 and a join unit 638. Flip-flops 626, 628, 632, and 634 receive a synchronizing clock signal 640(2), also referred to as a clock signal. Clock signal 640(2) can be the same clock signal as one or more of clock signals 640(0) and 640(1), a copy of one or more of clock signals 640(0) and 640(1), a clock signal that is synchronous with one or more of clock signals 640(0) and 640(1), and/or the like.

Flip-flop 626 retimes the signals received from flip-flop 620 of dual edge DBI retiming circuit 602 via signal path 660. Flip-flop 626 retimes the signals to the positive edge of clock signal 640(2). Flip-flop 626 transmits the retimed signals to flip-flop 628 via signal path 666. Flip-flop 628 is a latency matching flip-flop to match the delay of the positive edge signals at the output of flip-flop 628 with the delay of the negative edge signals at the output of flip-flop 634. Flip-flop 628 retimes the signals to the positive edge of clock signal 640(2). Flip-flop 628 transmits signals to join unit 638 via signal path 668. The signals include the positive edge signal group, the positive edge valid signal, and the positive edge DBI signal(s).

Similarly, flip-flop 632 retimes the signals received from flip-flop 624 of dual edge DBI retiming circuit 602 via signal path 664. Flip-flop 632 retimes the signals to the negative edge of clock signal 640(2). Flip-flop 632 transmits the retimed signals to flip-flop 634 via signal path 672. Flip-flop 634 retimes the signals to the positive edge of clock signal 640(2). As a result, the outputs of flip-flop 628 and flip-flop 634 are aligned with one another and synchronized to the positive edge of clock signal 640(2). Flip-flop 634 transmits signals to join unit 638 via signal path 674. The signals include the negative edge signal group, the negative edge valid signal, and the negative edge DBI signal(s).

Join unit 638 joins the processed positive edge signal group received from flip-flop 628 via signal path 668 with the processed negative edge signal group received from flip-flop 634 via signal path 674. After joining the two signal groups, join unit 638 transmits a copy of the original signals of the interconnect received by fork unit 606 of dual edge DBI transmitter 600. Join unit 638 transmits the copy of the original signals of the interconnect to one or more destination components via signal path 678. The one or more destination components can then reverse the data bus inversion that was applied to the interconnect prior to receiving the electronic signals of the interconnect at fork unit 606.

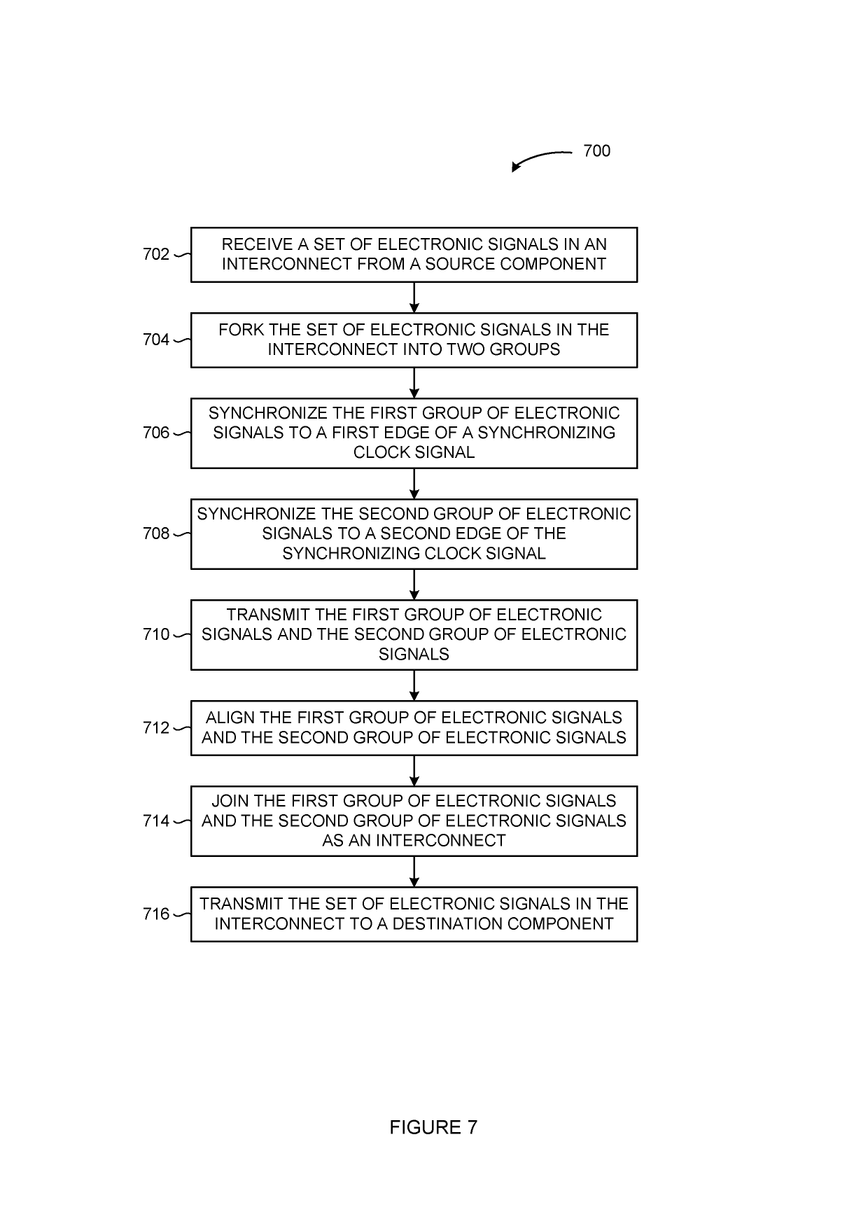

FIG. 7 is a flow diagram of method steps for transmitting electronic signals for an interconnect with the dual edge DBI system of FIGS. 6A-6C, according to various embodiments. Additionally or alternatively, the method steps can be performed by one or more alternative components associates with one or more processors including, without limitation, microcontrollers, RISC processors, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-6C, persons of ordinary skill in the art will understand that any system configured to perform the method steps, in any order, is within the scope of the present disclosure.

As shown, a method 700 begins at step 702, where dual edge DBI transmitter 600 receives a set of electronic signals in an interconnect from a source component. The signals include an interconnect, such as a data bus, an address bus, and/or other signals, that connect components in computing system 100. The signals further include a valid signal that is at a logic FALSE value when the signals of the interconnect are not valid and at a logic TRUE value when the signals of the interconnect are valid. Dual edge DBI transmitter 600 processes the signals of the interconnect when the valid signal is at a logic TRUE value and does not process the signals of the interconnect when the valid signal is at a logic FALSE value. The signals further include one or more DBI signals associated with the interconnect. The DBI signals are generated prior to being received by dual edge DBI transmitter 600. A DBI signal is at a logic FALSE value when the corresponding signals of the interconnect have not been inverted and a logic TRUE value when the corresponding signals of the interconnect have been inverted.

At step 704, dual edge DBI transmitter 600 forks, or divides, the set of electronic signals in the interconnect into two groups. Dual edge DBI transmitter 600 can divide an interconnect of 128 bits into a first group of 64 most significant bits and a second first group of 64 least significant bits. Alternatively, dual edge DBI transmitter 600 can divide the interconnect into a first group of 64 even numbered bits and a second group of 64 odd numbered bits. Alternatively, dual edge DBI transmitter 600 can divide the interconnect into two groups of 64 signals, where the signals in each group are routed in close proximity to one another on an integrated circuit, a substrate, a printed circuit board, and/or the like.

At step 706, dual edge DBI transmitter 600 synchronizes the first group of electronic signals to a first edge of a synchronizing clock signal. For example, dual edge DBI transmitter 600 can sample the positive edge signal group, the positive edge valid signal, and the positive edge DBI signal(s) on the positive edge of the synchronizing clock signal.

At step 708, dual edge DBI transmitter 600 synchronizes the second group of electronic signals to a second edge of the synchronizing clock signal. For example, dual edge DBI transmitter 600 can sample the negative edge signal group, the negative edge valid signal, and the negative edge DBI signal(s) on the negative edge of the synchronizing clock signal.

At step 710, dual edge DBI transmitter 600 transmits the first group of electronic signals and the second group of electronic signals. Dual edge DBI transmitter 600 transmits the first group of electronic signals, namely, the positive edge signal group, the positive edge valid signal, and the positive edge DBI signal(s), that are synchronized to the positive edge of the synchronizing clock signal. Further, dual edge DBI transmitter 600 transmits the second group of electronic signals, namely, the negative edge signal group, the negative edge valid signal, and the negative edge DBI signal(s), that are synchronized to the negative edge of the synchronizing clock signal.

As the signals propagate from the output of dual edge DBI transmitter 600 to the input of dual edge DBI receiver 604, dual edge DBI retiming circuit 602 can retime the signals to respective edges of the synchronizing clock signal. More specifically, dual edge DBI retiming circuit 602 can retime the first group of electronic signals, namely the positive edge signal group, the positive edge valid signal, and the positive edge DBI signal(s), to the positive edge of the synchronizing clock signal. Further, dual edge DBI retiming circuit 602 can retime the second group of electronic signals, namely, the negative edge signal group, the negative edge valid signal, and the negative edge DBI signal(s), to the negative edge of the synchronizing clock signal.

At step 712, dual edge DBI receiver 604 aligns the first group of electronic signals and the second group of electronic signals. Dual edge DBI receiver 604 retimes the first group of electronic signals received from dual edge DBI retiming circuit 602 to the positive edge of the synchronizing clock signal. Further, dual edge DBI receiver 604 performs latency matching flip-flop to match the delay of the first group of electronic signals with the delay of the second group of electronic signals.

Similarly, dual edge DBI receiver 604 retimes the second group of electronic signals received from dual edge DBI retiming circuit 602 to the negative edge of the synchronizing clock signal. Dual edge DBI receiver 604 then retimes the signals to the positive edge of the synchronizing clock signal. As a result, the first group of electronic signals and the second group of electronic signals are aligned with one another and synchronized to the positive edge of the synchronizing clock signal.

At step 714, dual edge DBI receiver 604 joins the first group of electronic signals and the second group of electronic signals into a copy of the original interconnect. Dual edge DBI receiver 604 joins the processed first group of electronic signals after positive edge DBI decoding with the processed second group of electronic signals after negative edge DBI decoding.

At step 716, dual edge DBI receiver 604 transmits the electronic signals in the interconnect to a destination component. After joining the two signal groups, dual edge DBI receiver 604 transmits a copy of the original signals of the interconnect received by dual edge DBI transmitter 600. Dual edge DBI receiver 604 transmits the copy of the original signals of the interconnect to one or more destination components.

The method 700 then terminates. Alternatively, the method 700 returns to step 702 to process additional electronic signals received via the interconnect.

In sum, a dual edge DBI system performs techniques for reducing IR drop in an electronic circuit. With the disclosed techniques, a signal interconnect transmitter receives a set of electronic signals included in an interconnect from one or more source components. The transmitter divides the set of electronic signals included in the interconnect into groups, such as into two groups that include approximately one-half of the signals included in the interconnect. The transmitter staggers the electronic signals included in the interconnect such that the electronic signals in one of the two groups transition on the positive (rising) edge of the clock signal and the electronic signals in the other of the two groups transition on the negative (falling) edge of the clock signal. Further, the transmitter applies data bus inversion (DBI) to the electronic signals included in the interconnect. The transmitter can stagger the electronic signals either before or after applying DBI to the signals included in the interconnect.

One or more dual edge DBI retiming circuits carry the electronic signals from the transmitter to a signal interconnect receiver. The dual edge DBI retiming circuits continue to transition one group of electronic signals on the positive edge of the clock signal and the other group of electronic signals on the negative edge of the clock signal. The dual edge DBI retiming circuits thereby maintain the staggering of the signal transitions applied by the transmitter. A signal interconnect receiver realigns the groups of electronic signals to transition on the same edge of the clock signal, such as the positive edge of the clock signal. The receiver joins the groups of electronic signals into a single interconnect. The receiver transmits the electronic signals in the joined interconnect to one or more destination components.

At least one technical advantage of the disclosed techniques relative to the prior art is that, with the disclosed techniques, the simultaneous transitioning of electronic signals in an interconnect is limited to 25% of the electronic signals on the positive edge of the clock signal and 25% of the electronic signals on the negative edge of the clock signal. By contrast, with prior conventional DBI techniques, the simultaneous transitioning of electronic signals in an interconnect can be up to 50% of the electronic signals. Therefore, the disclosed techniques reduce simultaneous switching by as much as 50% relative to conventional DBI approaches and as much as 75% relative to systems with that do not employ DBI. As a result, the IR drop resulting from simultaneous transitioning of electronic signals in an interconnect can be reduced significantly as compared to conventional approaches. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for transmitting data bus inversion (DBI) encoded electronic signals for an interconnect included in a computing system, the method comprising:
synchronizing a first group of the DBI encoded electronic signals to a first edge of a synchronizing clock signal;
synchronizing a second group of the DBI encoded electronic signals to a second edge of the synchronizing clock signal; and
transmitting the first group of the DBI encoded electronic signals and the second group of the DBI encoded electronic signals to a receiver.

2. The computer-implemented method of claim 1, further comprising:
receiving electronic signals from a source component;
dividing the electronic signals into a first group of electronic signals and a second group of electronic signals;
applying data bus inversion on the first group of electronic signals to generate the first group of the DBI encoded electronic signals; and
applying data bus inversion on the second group of electronic signals to generate the second group of the DBI encoded electronic signals.

3. The computer-implemented method of claim 2, wherein the receiver:
applies reverse data bus inversion on the first group of the DBI encoded electronic signals to generate a first group of DBI decoded electronic signals;
applies reverse data bus inversion on the second group of the DBI encoded electronic signals to generate a second group of DBI decoded electronic signals;
merges the first group of DBI decoded electronic signals and the second group of DBI decoded electronic signals to generate a copy of the electronic signals; and
transmits the copy of the electronic signals to a destination component.

4. The computer-implemented method of claim 1, wherein a source component:
applies data bus inversion on electronic signals to generate the DBI encoded electronic signals.

5. The computer-implemented method of claim 4, further comprising:
receiving the DBI encoded electronic signals from the source component; and
dividing the DBI encoded electronic signals into the first group of DBI encoded electronic signals and the second group of DBI encoded electronic signals.

6. The computer-implemented method of claim 5, wherein the receiver:
merges the first group of DBI encoded electronic signals and the second group of DBI encoded electronic signals to generate a copy of the DBI encoded electronic signals; and
transmits the copy of the DBI encoded electronic signals to a destination component.

7. The computer-implemented method of claim 6, wherein the destination component:
applies reverse data bus inversion on the copy of the DBI encoded electronic signals to generate DBI decoded electronic signals.

8. The computer-implemented method of claim 1, wherein a retiming circuit:
retimes the first group of the DBI encoded electronic signals to the first edge of the synchronizing clock signal; and
retimes the second group of the DBI encoded electronic signals to the second edge of the synchronizing clock signal.

9. The computer-implemented method of claim 1, wherein the receiver:
aligns the second group of the DBI encoded electronic signals with the first group of the DBI encoded electronic signals.

10. The computer-implemented method of claim 1, wherein:
the first edge of the synchronizing clock signal comprises a positive (rising) edge of the synchronizing clock signal; and
the second edge of the synchronizing clock signal comprises a negative (falling) edge of the synchronizing clock signal.

11. A system comprising:
a receiver; and
a transmitter coupled to the receiver that:
synchronizes a first group of DBI encoded electronic signals to a first edge of a synchronizing clock signal;
synchronizes a second group of the DBI encoded electronic signals to a second edge of the synchronizing clock signal; and
transmits the first group of the DBI encoded electronic signals and the second group of the DBI encoded electronic signals to the receiver.

12. The system of claim 11, wherein the transmitter further:
receives electronic signals from a source component;
divides the electronic signals into a first group of electronic signals and a second group of electronic signals;
applies data bus inversion on the first group of electronic signals to generate the first group of the DBI encoded electronic signals; and
applies data bus inversion on the second group of electronic signals to generate the second group of the DBI encoded electronic signals.

13. The system of claim 12, wherein the receiver:
applies reverse data bus inversion on the first group of the DBI encoded electronic signals to generate a first group of DBI decoded electronic signals;
applies reverse data bus inversion on the second group of the DBI encoded electronic signals to generate a second group of DBI decoded electronic signals;
merges the first group of DBI decoded electronic signals and the second group of DBI decoded electronic signals to generate a copy of the electronic signals; and
transmits the copy of the electronic signals to a destination component.

14. The system of claim 11, further comprising a source component, wherein the source component:
applies data bus inversion on electronic signals to generate the DBI encoded electronic signals.

15. The system of claim 14, wherein the transmitter further:
receives the DBI encoded electronic signals from the source component; and
divides the DBI encoded electronic signals into the first group of DBI encoded electronic signals and the second group of DBI encoded electronic signals.

16. The system of claim 15, further comprising a destination component, wherein the receiver further:
merges the first group of DBI encoded electronic signals and the second group of DBI encoded electronic signals to generate a copy of the DBI encoded electronic signals; and
transmits the copy of the DBI encoded electronic signals to the destination component.

17. The system of claim 16, wherein the destination component:
applies reverse data bus inversion on the copy of the DBI encoded electronic signals to generate DBI decoded electronic signals.

18. The system of claim 11, further comprising a retiming circuit, wherein the retiming circuit:
retimes the first group of the DBI encoded electronic signals to the first edge of the synchronizing clock signal; and
retimes the second group of the DBI encoded electronic signals to the second edge of the synchronizing clock signal.

19. The system of claim 11, wherein the receiver:
aligns the second group of the DBI encoded electronic signals with the first group of the DBI encoded electronic signals.

20. The system of claim 11, wherein:
the first edge of the synchronizing clock signal comprises a positive (rising) edge of the synchronizing clock signal; and
the second edge of the synchronizing clock signal comprises a negative (falling) edge of the synchronizing clock signal.
